(19) United States
(12) Patent Application Publication
(10) Pub. No.: US 2014/0028472 A1
(43) Pub. Date: Jan. 30, 2014

(54) Method and Apparatus for User Authentication and Security

(71) Applicant: Ford Global Technologies, LLC, Dearborn, MI (US)

(72) Inventor: Maria Eugenia Protopapas, Canton, MI (US)

(73) Assignee: Ford Global Technologies, LLC, Dearborn, MI (US)

(21) Appl. No.: 14/045,031

(22) Filed: Oct. 3, 2013

Related U.S. Application Data
(62) Division of application No. 13/278,270, filed on Oct. 21, 2011.

(51) Int. Cl. B60Q 9/00

(52) U.S. Cl. CPC B60Q 9/00
USPC 340/904

(57) ABSTRACT

A computer implemented method includes logging a GPS location in a wireless device responsive to a vehicle entering a parked state. The method also includes comparing device GPS coordinates to the logged GPS coordinates to determine if the device is in vehicle proximity, after the wireless device has moved a predetermined distance from the logged GPS location. The method additionally includes sending a signal to the vehicle to activate a user authentication process when the device is in vehicle proximity.

### CROSS-REFERENCE TO RELATED APPLICATIONS

This application is a division of U.S. application Ser. No. 13/278,270 filed Oct. 21, 2011, the disclosure of which is hereby incorporated in its entirety by reference herein.

### TECHNICAL FIELD

The illustrative embodiments generally relate to a method and apparatus for user authentication and security.

### BACKGROUND

Certain means of authenticating users using biometric functions already exist.

For example, U.S. App. Pub. 2002/0097145 relates to: A method and apparatus for preventing theft of, and/or facilitating authorized access to, automotive vehicles generally comprises an image acquisition device adapted to generate signals representative of a human facial image wherein a processor associated with the image acquisition device is adapted to operatively receive the signals and generate an output relative to recognition or non-recognition of the human facial image. A response interface is associated with the processor and adapted to effect a vehicle security measure responsive to the recognition or non-recognition of the human facial image. An enrollment interface is adapted for enrolling authorized human users.

The processor is adapted to compare signals generated by the image acquisition device with stored images of authorized users, generally by a face recognition engine which may be implemented with either a neural network or principal component analysis or their equivalent. Processing by the face recognition engine is facilitated by providing a morphological pre-processor which may screen images for quality or, in at least one embodiment, perform some verification functions. A postprocessor may be provided to make the determination of recognition or non-recognition based upon a predetermined threshold value of recognition.

A triggering event interface is provided for communicating to the system the existence of those conditions necessitating verification of the user. Such events may include the opening of a car door, attempts to start the vehicle or attempts to access the vehicle. A response interface is also provided for effecting appropriate vehicle security measures. The response interface is generally one or more interconnections to the vehicle's microprocessor, door lock relay or alarm system. This interface will function to disable operation of the vehicle and/or sound the alarm in the case of attempted unauthorized use or access and will also serve to facilitate access to the vehicle in the case of authorized use.

Or, for example, U.S. App. Pub. 2005/0193212 relates to: A combined individual authentication system includes a license information acquiring device for acquiring license information from a storage media which a driver carries before or after a vehicle runs, a biometric information acquiring device for acquiring biometric information of the driver, and a pre-stored information storing device for storing pre-stored license and biometric information of the driver. The authentication system also includes a license information authenticating device for authenticating the driver based on the pre-stored license information, a first permitting device for permitting at least one of functions which the vehicle equipped, when the license information authenticating device authenticates the driver as an authenticated driver, a biometric information authenticating device for authenticating the driver based on the pre-stored biometric information, when the license information authenticating device authenticates the driver as an authenticated driver, and a second permitting device for permitting at least one of functions which the vehicle equipped.

### SUMMARY

In a first illustrative embodiment, a computer implemented method includes logging a GPS location in a wireless device responsive to a vehicle entering a parked state. The method also includes, comparing device GPS coordinates to the logged GPS coordinates to determine if the device is in vehicle proximity, after the wireless device has moved a predetermined distance from the logged GPS location. The method additionally includes sending a signal to the vehicle to activate a user authentication process when the device is in vehicle proximity.

In a second illustrative embodiment, a computer implemented method includes engaging one or more vehicle sensors to detect the presence of one or more people in proximity to a vehicle. The method also includes alerting an approaching vehicle owner of the presence of one or more detected people in proximity to the vehicle.

In a third illustrative embodiment, a computer implemented method includes authenticating a user using a first authentication process outside a vehicle. The method also includes authenticating the user using a second authentication process inside the vehicle. Further, the method includes providing an override authentication process inside the vehicle, if either of the authentication processes fails to authenticate the user. If both authentication processes authenticate the user or if the override authentication process authenticates the user, full vehicle functionality is provided. If either authentication process fails to authenticate the user and if the override authentication process fails to authenticate the user, limited vehicle functionality is provided.

### BRIEF DESCRIPTION OF THE DRAWINGS

FIG. 1 shows an illustrative example of a vehicle computing system;

FIG. 2 shows an illustrative example of a biometric authentication start-up process;

FIG. 3 shows an illustrative example of a security process; and

FIG. 4 shows an illustrative example of an authentication and security process.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

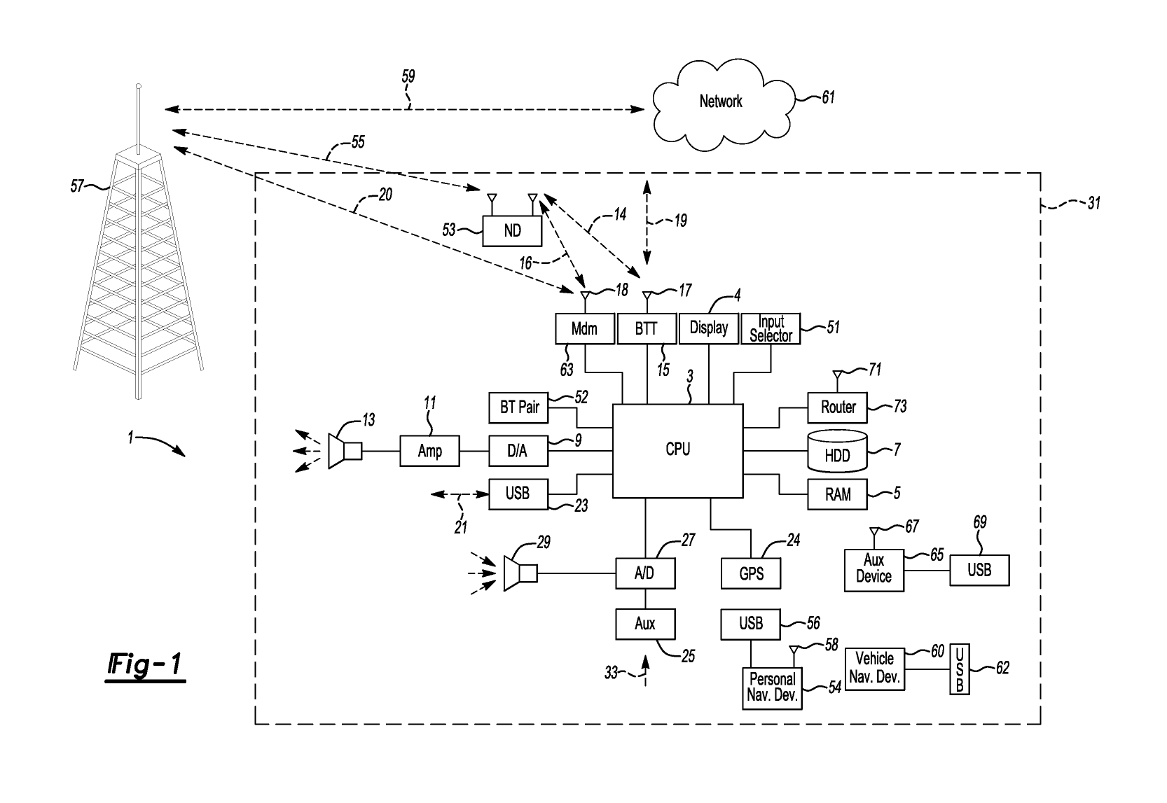

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, audible speech and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory.

The processor is also provided with a number of different inputs allowing the user to interface with the processor. In this illustrative embodiment, a microphone 29, an auxiliary input 25 (for input 33), a USB input 23, a GPS input 24 and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device can then be used to communicate 59 with a network 61 outside the vehicle 31 through, for example, communication 55 with a cellular tower 57. In some embodiments, tower 57 may be a WiFi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include WiFi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of with Code Domian Multiple Access (CDMA), Time Domain Multiple Access (TDMA), Space-Domian Multiple Access (SDMA) for digital cellular communication. These are all ITU IMT-2000 (3G) compliant standards and offer data rates up to 2 mbs for stationary or walking users and 385 kbs for users in a moving vehicle. 3G standards are now being replaced by IMT-Advanced (4G) which offers 100 mbs for users in a vehicle and 1 gbs for stationary users. If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11g network (i.e., WiFi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (firewire), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a WiFi 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing the process, since the wireless device would not “send and receive” information with itself. One of ordinary skill in the art will understand when it is inappropriate to apply a particular VACS to a given solution. In all solutions, it is contemplated that at least the vehicle computing system (VCS) located within the vehicle itself is capable of performing the exemplary processes.

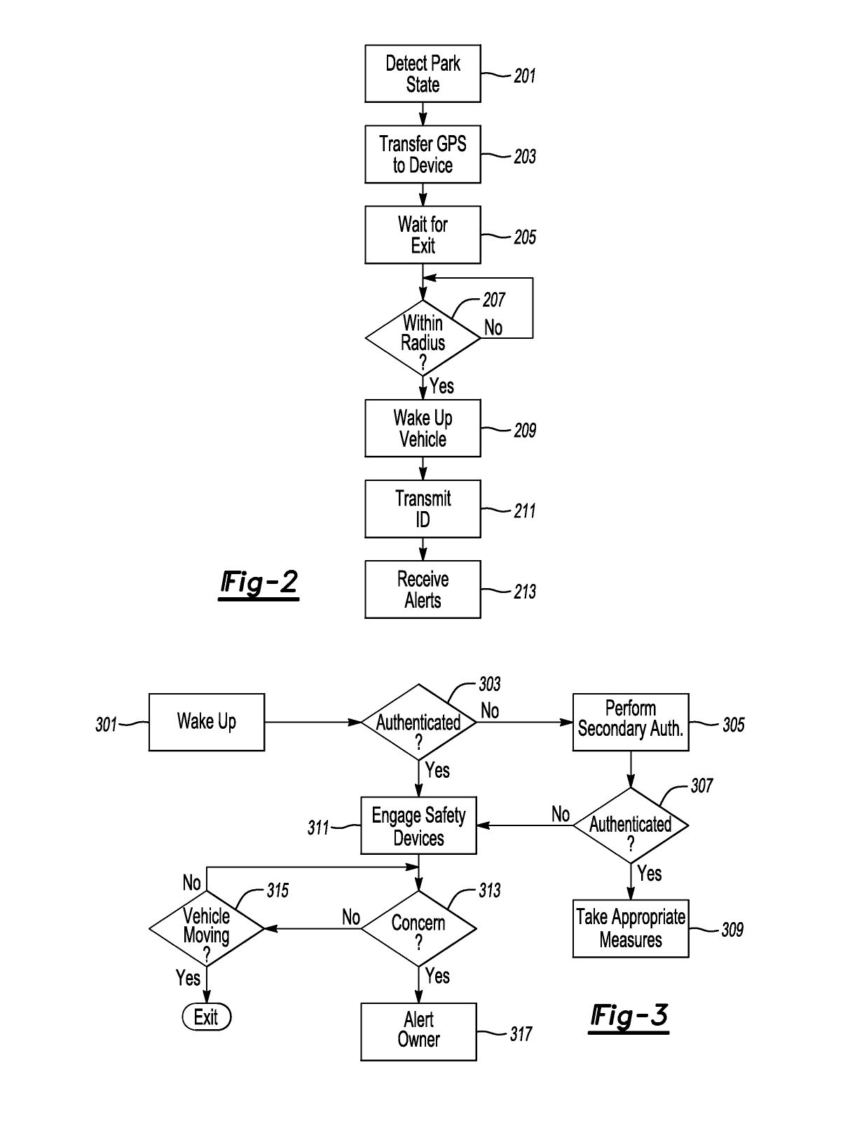

FIG. 2 shows an illustrative example of a biometric authentication start-up process. In this illustrative example, the process focuses on when to engage a user authentication process, such as, but not limited to, a biometric process.

In this illustrative example, the process detects that the vehicle has entered a park state 201. This could also be a stop state, an open door state, a passenger exit state, etc. Essentially, the process is aware that a user is likely to or has exited a vehicle.

Once this state has been detected, the process transfers 203 the GPS location of the vehicle to a wireless device (or obtains the GPS location, if the process itself is running on the wireless device).

Since the vehicle location will be used in conjunction with a determination that the user has re-entered in proximity to the vehicle, the process first waits until the user has exited such a perimeter (and perhaps for a period of time thereafter) 205. Once the “exit” has been detected, the proximity detection process 207 is engaged. If the GPS coordinates of the wireless device are within a certain radius of the stored GPS coordinates of the vehicle, a “wake up” signal can be sent to the vehicle to wake up authentication 209.

In conjunction with the wake up function, and/or in response to a subsequent request from the vehicle, one or more forms of driver identification can be transferred 211. The user can then be authenticated based on this transmitted information, and can subsequently receive alerts 213 from the vehicle. The alerts are sent to a known, authenticated customer, in this example.

FIG. 3 shows an illustrative example of a security process. In this illustrative embodiment, a vehicle process is woken up 301 by a request (for example, but not limited to, a request such as that sent in conjunction with FIG. 2). In this example, the process first determines if the user has been authenticated 303. If an approaching user has been authenticated by the remote data exchange process (which could include biometric data, for example), safety devices may be engaged 311.

Safety devices can include, but are not limited to, exterior vehicle cameras, sensors and proximity detection. Vehicle cameras and sensors can be used to detect other parties that may be crouching near a vehicle, approaching the vehicle from another vector, or aggressively approaching the vehicle. Detection of a lurking or aggressively approaching party 313 may trigger one or more alerts to the owner 317. This detection process can continue up until the vehicle is moving 315 (at which point lurking parties have presumably failed to intercept the owner).

In one non-limiting example, a 360 degree or other arc camera or sensor is used to check the perimeter of the vehicle for approaching or lurking parties. Detection of an unexpected party can cause activation of lights, triggering of a horn or alarm, and/or notification to the driver approaching the vehicle. Vehicle radar or other detection methods may also be employed to detect unwanted persons in the vicinity of the vehicle.

If the user is not authenticated 303 or cannot be authenticated (for example, a voice recognition or iris recognition may be difficult if a user is tired, sick or intoxicated), a secondary authorization may be engaged 305. The secondary authentication may include, but is not limited to, a pass code, secondary biometrics, password, phrase/response check, etc.

If the secondary authentication also fails, appropriate security measures may be taken 309. These can be as simple as denying entry to the user, or could include, but are not limited to, alerting the authorities, alerting an alternative owner phone number, putting the vehicle in a limited drive capability, requiring an additional, in-vehicle authentication, etc.

For example, in one instance, the vehicle could have stored therein an alternative phone number. Using wireless communication, which may even be established through the device from which the failed authentication was transmitted, the vehicle could contact the alternate number to alert an owner's alternative device (or a police phone number) that the vehicle may be compromised.

In another instance, a limited drive capability may be engaged. For example, the process may engage a restriction on where the vehicle can be driven, permitting, for example, only driving within a certain radius, driving only to and from designated destination (within, for example, a designated geographic corridor), etc.

In still a third instance, secondary, in-vehicle authentication may be required. This could also include biometric identification, or a password input, etc. Additionally or alternatively, a remote authentication could be employed, where a second party related to the vehicle is asked to approve the usage of the vehicle by the party who is attempting to authenticate and access the vehicle.

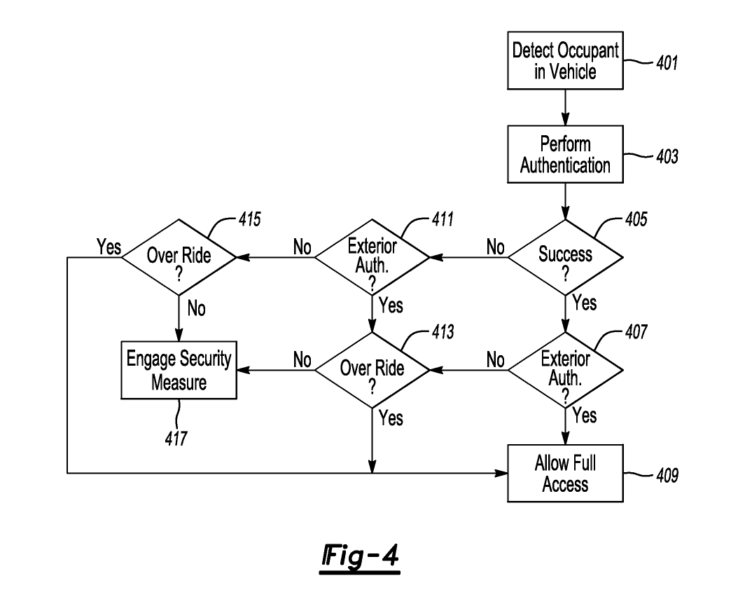

FIG. 4 shows an illustrative example of an authentication and security process. In this illustrative example, an occupant has entered a vehicle. The occupant may have entered using a key, and the occupant may or may not have passed a first authentication process, such as, but not limited to, a biometric authentication process. In the exemplary process shown in FIG. 4, the process detects an occupant in the vehicle 401. Typically, although not necessarily, the occupant will be a driver. In one embodiment, detection of a driver and at least one passenger can cause an authentication check on the passenger if the check on the driver fails (in case, for example, a friend is driving someone home who has had too much to drink).

The process will, in this example, attempt to authenticate the driver 403. This can be done using biometric sensors, such as, but not limited to, facial recognition, fingerprint reading, iris scanning, etc. Or a more basic system, such as password input, may be employed. If the authentication is successful 405, the process determines if the exterior authentication was also successful 407. If both authentications were successful, then it is assumed that the driver is appropriate and full vehicle functionality is provided.

If the interior authentication was successful and the exterior authentication was not successful (but, for example, the user used a key to enter the vehicle regardless), a possible option to override could be provided 413. This could correspond to a temporary or permanent passcode, or could include a second party authentication measure as discussed above, or other suitable override. If the override is correctly processed, again, full access to vehicle systems will be provided.

If the interior authentication is unsuccessful, but the exterior authentication was 411, then again, an override option may be engaged. For example, if a person is assisting a tired or inebriated vehicle owner home, the owner may be able to process the exterior authentication. But then, since the owner is not seated in the driver seat, an interior process, such as a driver biometric process, may fail. In such a case, the override may be a means to allow the non-owner to operate the vehicle.

If both the interior and exterior authentications fail, an override option 415 may still exist. For example, if the vehicle was loaned to someone, a temporary usage password or permanent password could be given to the borrower, in order to allow them to use the vehicle. In one example, the temporary password may expire after some brief time period (a few hours, a few days, a few weeks, etc.). If any override states are correctly navigated, full vehicle access may be provided.

In the event that biometric or other interior/exterior authentication fails, and override of the authentication process is unsuccessful, the system may engage a security measure 417. This can include, but is not limited to, refusing to start the vehicle, notifying the police, starting the vehicle in a limited-range or limited-destination mode, notifying an owner, triggering an alarm, etc.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A computer implemented method comprising:
engaging one or more vehicle sensors to detect the presence of one or more people in proximity to a vehicle;
alerting an approaching vehicle owner of the presence of one or more detected people in proximity to the vehicle.

2. The method of claim 1, wherein the sensors include one or more vehicle cameras.

3. The method of claim 2, wherein at least one camera is a 360-degree camera.

4. The method of claim 1, wherein the sensors include vehicle radar.

5. The method of claim 1, wherein the sensors are configured to detect a person crouched near a perimeter of a vehicle.

6. The method of claim 1, wherein the sensors are configured to detect a person approaching a vehicle from a direction different from the approaching vehicle owner.

7. A non-transitory computer readable storage medium, storing instructions that, when executed by a processor, cause the processor to perform a method comprising:
engaging one or more vehicle sensors to detect the presence of one or more people in proximity to a vehicle;
alerting an approaching vehicle owner of the presence of one or more detected people in proximity to the vehicle.

8. The storage medium of claim 7, wherein the sensors include one or more vehicle cameras.

9. The storage medium of claim 8, wherein at least one camera is a 360-degree camera.

10. The storage medium of claim 7, wherein the sensors include vehicle radar.

11. The storage medium of claim 7, wherein the sensors are configured to detect a person crouched near a perimeter of a vehicle.

12. The storage medium of claim 7, wherein the sensors are configured to detect a person approaching a vehicle from a direction different from the approaching vehicle owner.

13. A system comprising:
a processor configured to:
engage one or more vehicle sensors to detect the presence of one or more people in proximity to a vehicle;
alert an approaching vehicle owner of the presence of one or more detected people in proximity to the vehicle.

14. The system of claim 13, wherein the sensors include one or more vehicle cameras.

15. The system of claim 14, wherein at least one camera is a 360-degree camera.

16. The system of claim 13, wherein the sensors include vehicle radar.

17. The system of claim 13, wherein the sensors are configured to detect a person crouched near a perimeter of a vehicle.

18. The system of claim 13, wherein the sensors are configured to detect a person approaching a vehicle from a direction different from the approaching vehicle owner.
